(19) United States
(12) Patent Application Publication
(10) Pub. No.: US 2019/0355002 A1
(43) Pub. Date: Nov. 21, 2019

(54) SALES MANAGEMENT METHOD AND COMPUTER PROGRAM RECORDING MEDIUM THEREFOR

(71) Applicants: Cheolshik CHOI, Ulsan (KR); Eunmi LEE, Ulsan (KR)

(72) Inventors: Cheolshik CHOI, ulsan (KR); Eunmi LEE, Ulsan (KR); Hyejin CHOI, Ulsan (KR); Junwon CHOI, Ulsan (KR)

(21) Appl. No.: 16/301,557

(22) PCT Filed: Mar. 17, 2017
(86) PCT No.: PCT/KR2017/002915

§ 371 Date: Aug. 9, 2019

(30) Foreign Application Priority Data
May 19, 2016 (KR) 10-2016-0061628

(51) Int. Cl. G06Q 30/02; G06F 16/28

(52) U.S. Cl. CPC G06Q 30/0204; G06F 16/285

(57) ABSTRACT

The present invention relates to a sales management method and a computer program recording medium therefor. The present invention is configured such that a headquarters system obtain and analyze product purchase information and purchase customer characteristics by using a POS terminal and a camera which are installed in an individual sales branch, and provides order reference information so as to minimize product inventory of the individual sales branch by using the analysis result.

### TECHNICAL FIELD

The present invention relates to a sales management method and a computer program recording medium therefor, wherein a headquarters system is configured to obtain and analyze product purchase information and purchase customer characteristics by using a POS terminal and a camera which are installed in an individual sales branch, and provide order reference information so as to minimize product inventory of the individual sales branch by using the analysis result.

### BACKGROUND ART

As a distribution environment of goods has changed, a distribution structure of existing retail stores, where product management has been performed by individual store units, is changing to a convenience store type where product management is performed in the form of a chain network.

Convenience stores have a structure in which a headquarters receives product orders from individual sales branches provided in each region, and supplies the ordered products to the sales branches through a distribution network of the headquarters.

Recently, in addition to general convenience stores selling daily necessities, sales branches that sell products for specific purposes such as pharmacies are changing into a chain-like distribution structure.

Generally, in sales branches, logistics management such as ordering, receiving, inspecting, displaying, sales, and returning of products are performed in a unit of days. Among products, for various kinds of products with small quantity, products with short shelf life such as fresh foods and dairy products etc., and current affair related publications product such as daily or weekly newspapers, logistics management for the same is performed in a unit of days since such products are rotated faster than other products.

During logistics management, several items are discarded just before the expiration date because they are not sold, or are returned to headquarters and deducted from the inventory.

However, in product ordering of a conventional individual sales branch, in general, an inventory quantity of each product has been simply considered, or the owner who operates the corresponding sales branch determines a product to be ordered and a quantity thereof on the basis of his or her experience.

For example, in general, when an inventory of an A product is not enough, the owner determines the amount of new order on the basis of his or her experience, and the owner determines an order of a product that is determined to be additionally required taking into account the season or weather.

In order to help the same, there is purposed a method of, by a headquarters system, analyzing previous product orders and return data of individual sales branches, and analyzing inventory data to provide information of recommended order products. However, there is limit in using a result of simple inventory analysis of products, as order reference information of actual individual sales branches.

Due to the above limitation, a number of individual sales branches, especially the branches operated by owners with limited sales experience, increases in an inventory management burden due to excessive product orders. On the other hand, for products that are likely to be purchased by customers, sales loss occurs due to an insufficient inventory.

### DISCLOSURE

### Technical Problem

Accordingly, the present invention has been made keeping in mind the above problems occurring in the prior art, and an object of the present invention is to provide a sales management method and a computer program recording medium therefor, wherein a headquarters system is configured to obtain and analyze product purchase information and purchase customer characteristics by using a POS terminal and a camera which are installed in an individual sales branch, and provide order reference information so as to minimize product inventory of the individual sales branch by using the analysis result.

### Technical Solution

According to an aspect of the present invention for achieving the above object, there is provided a sales management method, wherein the method is a product sales management method executed in a headquarters system in association with a sales branch system including a POS terminal and a camera through a network, the method comprising: step 1) of obtaining purchase customer characteristics of each product and purchase customer characteristics of each sales branch based on customer facial information, product purchase information, and sales branch identification information obtained from at least one sales branch system, wherein the customer facial information is facial information of an individual customer which is captured by the camera provided in each sales branch system, the product purchase information is product purchase information of an individual customer which is recognized by the POS terminal provided in each sales branch system, and the purchase customer characteristics are at least one of a gender and an age of a customer, and are classified into at least one type for each purchase customer characteristic; and step 2) of providing order reference information to an individual sales branch system, wherein the order reference information is generated based on at least one of purchase customer characteristics of each product and purchase customer characteristics of each sales branch, and is product information which is expected to be purchased in the individual sales branch.

Preferably, the step 1) may include: step 11) of receiving the customer facial information, the product purchase information, and the sales branch identification information from at least one sales branch system; and step 12) of obtaining the purchase customer characteristics of each product based on the customer facial information and the product purchase information, and obtaining the purchase customer characteristics of each sales branch based on the customer facial information and the sales branch identification information.

Preferably, the step 1) may include step 101) of obtaining the purchase customer characteristics of each product and the purchase customer characteristics of each sales branch by receiving the same from at least one sales branch system, wherein the sales branch system obtains the purchase customer characteristics of each product based on the customer facial information and the product purchase information, and the sales branch system obtains the purchase customer characteristics of each sales branch based on the customer facial information and the sales branch identification information.

Preferably, the order reference information is configured to select as a reference sales branch a sales branch that is classified to have high sales performance according to a preset reference among a plurality of sales branch having an identical type of purchase customer characteristic, and to generate and provide product purchase information of the reference sales branch as order reference information for other sales branch systems having the identical type of purchase customer characteristic.

Preferably, the order reference information is configured to select as a reference product a product that is classified to have high sales performance according to a preset reference among a plurality of products having an identical type of purchase customer characteristic, and to generate and provide information of the reference product as order reference information for sales branch systems having a type of purchase customer characteristics which is identical to the purchase customer characteristics of the reference product.

Preferably, in the present invention, when the purchase customer characteristics are a customer gender, the purchase customer characteristics are classified into male and female types, and when the purchase customer characteristics are a customer age, the purchase customer characteristics are classified into types according to an age range.

Preferably, the purchase customer characteristics are classified by a combination type combining a gender type and an age type.

Preferably, in the present invention, in the step 1), the purchase customer characteristics of each product and the purchase customer characteristics of each sales branch are obtained in a preset customer characteristic obtaining period, and in the step 2), the order reference information is provided in a preset reference information providing period.

Preferably, at least one of the customer characteristic obtaining period and the reference information providing period is managed in a separate period preset for each product.

Preferably, the headquarters system further associates with an information providing agency system providing weather information, wherein in the step 1), purchase customer characteristics of each weather state are further obtained, and in the step 2), the order reference information is generated based on at least one of the purchase customer characteristics of each product, the purchase customer characteristics of each sales branch, and the purchase customer characteristics of each weather state.

Preferably, the order reference information is configured to select as a reference sales branch a sales branch that is classified to have high sales performance among a plurality of sales branches having an identical type of purchase customer characteristics under one weather state, and to generate and provide product purchase information of the reference sales branch as order reference information for other sales branch systems having the identical type of purchase customer characteristics under the corresponding weather state.

Preferably, the order reference information is configured to select as a reference product a product that is classified to have high sales performance among a plurality of products having an identical type of purchase customer characteristics under one weather state, and to generate and provide information of the reference product as order reference information for sales branch systems having a type of purchase customer characteristics which is identical to the purchase customer characteristics of the reference product under the corresponding weather state.

Preferably, the headquarters system further manages inventory information of each product for the individual sales branch, and in the step 2), in the order reference information provided to the individual sales branch system, a product which remains in inventory a preset reference or more is not included in order reference information of the corresponding sales branch.

Preferably, in the present invention, the sales management method may further include: step 3) of receiving order information from the individual sales branch system; and step 4) of applying a preset payment preference condition to a product included in the order reference information among products included in the order information.

According to another aspect of the present invention, there is provided a sales management method, wherein the method is a product sales management method executed in a headquarters system in association with a sales branch system provided with a POS terminal, a camera, and a microphone through a network, the method comprising: step 1) of obtaining purchase customer characteristics of each product and purchase customer characteristics of each sales branch based on at least one of customer facial information, customer voice information, product purchase information, and sales branch identification information obtained from at least one sales branch system, wherein the customer facial information is facial information of an individual customer which is captured by the camera provided in each sales branch system, the customer voice information is voice information of an individual customer which is obtained from the microphone provided in each sales branch system, the product purchase information is product purchase information of an individual customer which is recognized from the POS terminal provided in each sales branch system, and the purchase customer characteristics are at least one of a gender and an age of a customer, and are classified into at least one type for each purchase customer characteristic; and step 2) of providing order reference information to an individual sales branch system, wherein the order reference information is generated based on at least one of the purchase customer characteristics of each product and the purchase customer characteristics of each sales branch, and is product information which is expected to be purchased in the individual sales branch.

According to another aspect of the present invention, there is provided a computer readable recording medium in which a computer program for executing the sales management method is recorded.

### Advantageous Effects

As described above, in the present invention, a headquarters system analyzes product purchase information and purchase customer characteristics of individual sales branches, and provides order reference information so as to minimize a product inventory of individual sales branches by using the analyzed result. Accordingly, inventory management burden of individual sales branches can be reduced, and sales can be improved.

In addition, for customers who visit sales branches, products with high demand are not out of stock, and are kept in a ready stock condition, so the convenience of purchasing the products can be improved.

In addition, for a headquarters, sales at the headquarters level can be improved, and product planning and inventory management are available considering purchase customer characteristics.

### DESCRIPTION OF DRAWINGS

FIG. 1 is a configuration diagram of a system in which a sales management method according to an embodiment of the present invention is executed.

FIG. 2 is a headquarters configuration diagram according to an embodiment of the present invention.

FIG. 3 is a configuration diagram of a sales branch system according to an embodiment of the present invention.

FIG. 4 is a view of a flowchart of a sales management method according to an embodiment of the present invention.

FIG. 5 is a view of an example of a data table showing purchase customer characteristics of each product according to an embodiment of the present invention.

FIG. 6 is a view of an example of a data table showing purchase customer characteristics of each sales branch according to an embodiment of the present invention.

FIG. 7 is a view of an example of a data table showing an identical type of purchase customer characteristics according to an embodiment of the present invention.

FIG. 8 is a view of an example of a data table showing an identical type of purchase customer characteristics according to another embodiment of the present invention.

### BEST MODE

It should be noted that the present invention may be embodied in many different forms without departing from the spirit and significant characteristics of the present invention. Therefore, the embodiments of the present invention are disclosed only for illustrative purposes and should not be construed as limiting the present invention.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element. The term “and/or” includes any and all combinations of one or more of the associated listed items.

It should be understood that when one element is referred to as being “connected to” or “coupled to” another element, it may be connected directly to or coupled directly to another element, or be connected to or coupled to another element having the other element intervening therebetween. On the other hand, it is to be understood that when one element is referred to as being “connected directly to” or “coupled directly to” another element, it may be connected to or coupled to another element without the other element intervening therebetween.

Terms used herein are used only in order to describe specific embodiments rather than limiting the present invention. As used herein, the singular forms are intended to include the plural forms as well, unless the context clearly indicates otherwise. It will be further understood that the terms “comprises” or “have” used in this specification, specify the presence of stated features, processes, operations, components, parts, or a combination thereof, but do not preclude the presence or addition of one or more other features, numerals, processes, operations, components, parts, or a combination thereof.

Unless otherwise defined, all terms including technical and scientific terms used herein have the same meaning as commonly understood by one of ordinary skill in the art to which the present invention belongs. It should be understood that the terms defined by the dictionary are identical with the meanings within the context of the related art, and they should not be ideally or excessively formally defined unless the context clearly dictates otherwise in this specification.

Hereinafter, exemplary embodiments of the invention will be described in detail with reference to the accompanying drawings. The same or corresponding elements will be consistently denoted by the same respective reference numerals and described in detail no more than once regardless of drawing symbols. When the functions of conventional. elements and the detailed description of elements related with the present invention may make the gist of the present invention unclear, a detailed description of those elements will. be omitted

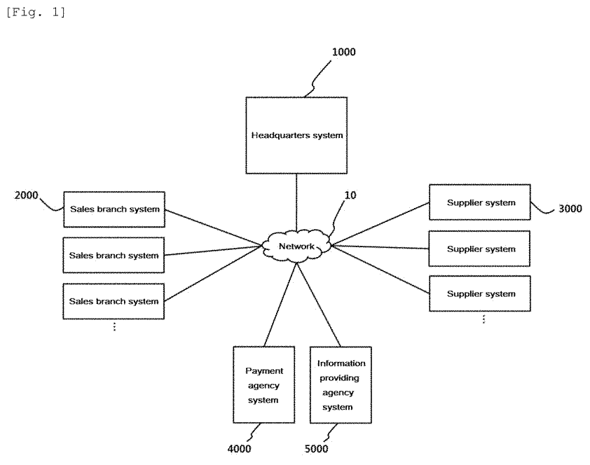

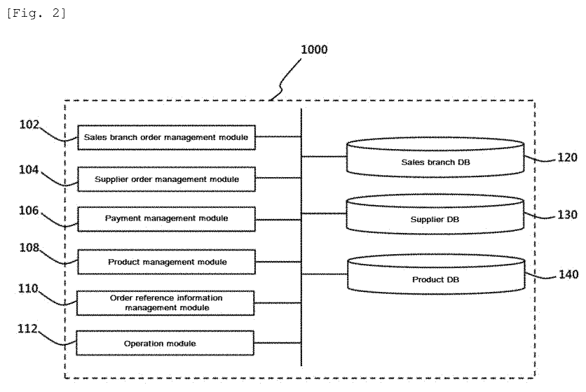

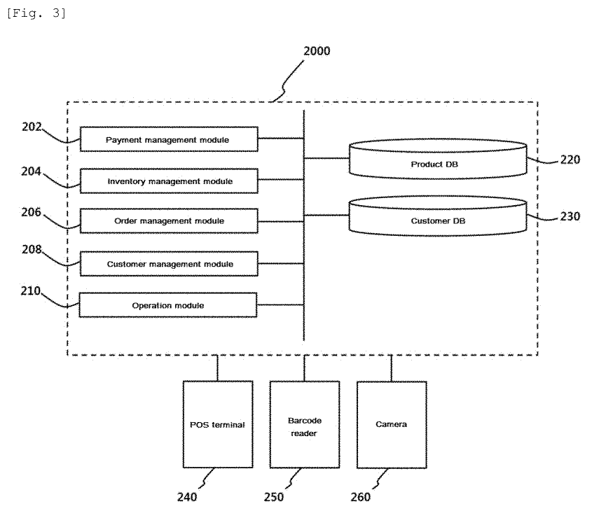

FIG. 1 is a configuration diagram of a system in which a sales management method according to an embodiment of the present invention is executed, FIG. 2 is a configuration diagram of a headquarters system according to an embodiment of the present invention, and FIG. 3 is a configuration diagram of a sales branch system according to an embodiment of the present invention.

A headquarters system 1000 of the present embodiment is connected to a sales branch system 2000, a supplier system 3000, a payment agency system 4000, and an information providing agency system 5000 through a network 10. The headquarters system 1000 executes an overall range of a product sales management method including product supply to sales branches, product order to suppliers, payment for sales branches and for suppliers, inventory management, return processing, etc.

In an example, a “headquarters” of the present embodiment may be understood as a headquarters of a convenience store chain network which receives product orders from individual convenience stores in each area, and supplies the ordered products to the individual convenience stores through a headquarters distribution network.

In another example, a “headquarters” of the embodiment may be understood as a headquarters of a pharmacy chain network which receives drug orders from individual pharmacies provided in each area, and supplies the ordered drugs to individual pharmacies through a headquarters distribution network. In addition, the headquarters of the present embodiment may be various distributors connected to sales branches of a retail store provided in each area through a chain network.

Particularly, the headquarters system 1000 of the present embodiment is configured to obtain and analyze product purchase information and purchase customer characteristics by using a sales branch system 2000 provided with a POS terminal 240 and a camera 260 in association with a network, and to provide order reference information to each sales branch by using the analyzed result so as to minimize a product inventory of an individual sales branch.

The purchase customer characteristics may be obtained through facial recognition such as customer gender and age, and may be customer biological information that is determined to influence a preference of product purchase.

In an example, purchase preference of each product may vary according to a customer gender (male/female). For example, for snacks, men prefer snacks such as potato chips that are suitable for alcoholic drinks, but women may prefer snacks such as crackers with low calories.

In another example, purchase preference of each product may vary according a customer age (10/20/30/40/50 or more). For example, in case of drinks, teenagers prefer highly stimulating energy drinks, while those in their 50s prefer tea drinks with less stimulation.

In another example, a purchase preference of each product may vary more detail according to a combination of a customer gender and a customer age. For example, for snacks, teenage boys may prefer chocolate biscuits with sweetness, while men in their 40s may prefer snacks as potato chips that are suitable for alcoholic drinks, women in their 20s may prefer snacks such as crackers that are not high in calories, but females in their fifties may prefer wafers that are not as stimulating.

A customer who purchases a product in a corresponding sales branch may vary in gender or age according to regional and environmental factors of an individual sales branch.

In an example, convenience stores nearby a main gate of a school have a large floating population of teens, and thus many products that teenagers prefer may be purchased. Such a purchase preference may also vary depending on whether the school is a boys school or a girls school.

In another example, convenience stores nearby a shopping mall where a number of restaurants and bars are present have a large floating population of men in their 30s and 40s, and thus many products that men in their 30s and 40s prefer may be purchased.

Accordingly, when such purchase customer characteristics are accurately identified for each individual sales branch, individual sales branches may order products that are expected to be in high demand in advance, and secure an enough inventory to prevent sales decline due to insufficient inventory so as to increase sales. In addition, ordering for products that are not expected to have high demand may be reduced or new ordering therefor may be stopped so that inventory management and returning the same may be reduced by minimizing a product inventory of a corresponding sales branch.

For the same, the headquarters system 1000 of the present embodiment is configured to separately generate and provide order reference information for each individual sales branch system so as to minimize a product inventory of the individual sales branch.

The sales branch system 2000 is a product management system operated in an individual sales branch. The sales branch system 2000 includes a POS terminal 240 for payment processing of a customer who has purchased a product, and a barcode reader 250 for product recognition, and executes overall functions of product sales management of the sales branch which includes product order, inventory management, customer purchase payment processing, headquarters payment processing, returning processing, etc. by being connected to the headquarters system 1000 and the payment agency system 4000 through the network 10.

Particularly, the sales branch system 2000 of the present embodiment may obtain customer facial information by using a camera 260. Customer facial information may be, for example, a video image itself obtained by capturing a customer face, or customer gender or age recognition information generated by recognizing a facial image may become customer facial information. A method of estimating gender or age of a person by using facial video recognition is known through various known facial recognition methods, and thus a detailed description thereof will be omitted.

The sales branch system 2000 of the present embodiment may obtain product purchase information of a product record which is purchased by a customer by using the POS terminal 240 and the barcode reader 250.

In an example, product purchase information may be obtained in a list form recording which products have been purchased by each customer who has made the payment. When such product purchase information of each individual customer is collected in a unit of days, the same may become daily product purchase information of the corresponding sales branch, and when daily product purchase information is collected in a unit of weeks, the same may become weekly product purchase information of the corresponding.

The supplier system 3000 of the present embodiment may be understood as a manufacturer or distributor system that supplies products by receiving orders from the headquarters system 100.

The payment agency system 4000 of the present embodiment may be understood as a system of a credit card company, a bank, etc. that process purchase payment between a customer and the sales branch system 2000, product supply payment between the sales branch system 2000 and the headquarters system 1000, and product supply payment between the headquarters system 1000 and the supplier system 3000.

The information providing agency system 5000 of the present embodiment may be understood as an information providing agency system that provides additional information (for example, weather information) required for generating order reference information of an individual sales branch from the headquarters system 1000.

The additional information may be external factor information that is determined to influence product purchase preference such as purchase customer characteristics (gender, age). In an example, the information may be a weather state.

For example, purchase preference of each product may vary according a weather state (sunny/cloudy/rainy). For example, on a sunny day, hats are preferred to shade a user from the sun, but umbrellas may be preferred on a cloudy or rainy day.

In another example, purchase preference of each product may vary according a weather state (hot/warm/cold). For example, cold soft drinks may be preferred in hot weather, but warm coffees may be preferred in mild weather or cold weather.

In another example, purchase preference of each product may vary more detail according to a combination of a weather state (sunny/cloudy/rainy), and a customer gender and a customer age. For example, in hot weather, teenagers may prefer cold soft drinks, while men in their forties may prefer canned beer, while women in their 20s prefer diet soda that are not high in calories, and while women in their 50s prefer regular water.

Considering the same, the headquarters system 1000 of the present embodiment is configured to obtain and analyze purchase customer characteristics and additional information such as a weather state, and to separately generate and provide order reference information that minimizes a product inventory of an individual sales branch for each individual sales branch system 2000 by using the analyzed result.

The network 10 of the present embodiment means a general communication network such as the Internet or an intranet, and may be understood to cover both wired and wireless networks.

Meanwhile, in the above description, the “system” means a system with a logical concept which functions as a server or client under a general server-client environment. For example, the system may be implemented by a general computing means using web service or application service (for example, PC, tablet PC, smartphone, server type computer).

Meanwhile, the headquarters system 1000 of the present embodiment includes: a sales branch order management module 102 for product supply processing to sales branches, a supplier order management module 104 for product order processing to suppliers, a payment management module 106 for payment processing for sales branches and suppliers, a product management module 108 for inventory management and returning processing, and an operation module 112 for general system environment operation. Particularly, the headquarters system 1000 of the present embodiment includes an order reference information management module 110 generating and providing order reference information in association with the sales branch system 2000 and the information providing agency system 5000.

In addition, the headquarters system 1000 of the present embodiment includes a sales branch DB 120 managing sales branch related information, a supplier DB 130 managing supplier related information, and a product DB 140 managing information related to product supply, inventory, and returning.

The sales branch system 2000 of the present embodiment includes a POS terminal 240 for payment processing of a customer who has purchased a product, a barcode reader 250 for recognizing a product item, and a camera 260 for obtaining customer facial information. The camera 260 captures a facial image of a customer who is performing payment action in front of the POS terminal 240 whenever a purchase payment event (for example, payment approval, receipt issue) occurs for each customer through the POS terminal 240.

The sales branch system 2000 of the present embodiment includes: a payment management module 202 for customer payment processing and headquarters payment processing; an inventory management module 204 for managing an inventory product record; an order management module 206 for product order and returning processing to the headquarters; a customer management module 208 obtaining and managing customer information including customer facial information obtained from the camera; and an operation module 210 for managing general system environment operation. The order management module 206 may provide to an operator of the sales branch system 2000 order reference information that is generated and provided from the headquarters system 1000.

In addition, the sales branch system 2000 of the present embodiment includes a product DB 220 managing product related information, and a customer DB 230 managing customer related information.

Module configurations of each system described above have a functional concept, and some modules may be integrated into one module or may be separately configured by a detailed function.

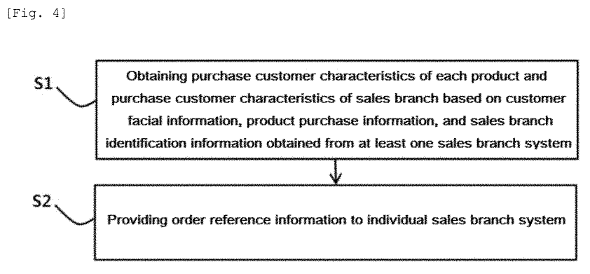

FIG. 4 is a view of a flowchart of a sales management method according to an embodiment of the present invention.

A flowchart of FIG. 4 is executed in the headquarters system 1000 in association with the sales branch system 2000 including the POS terminal 240 and the camera 260 through the network 10.

In S1, on the basis of customer facial information, product purchase information and sales branch identification information obtained from at least one sales branch system 2000, purchase customer characteristics of each product, and purchase customer characteristics of each sales branch are obtained.

Purchase customer characteristics of each product may be understood as information that matches a purchase amount of a particular product with a customer with certain characteristics. For example, for an A product, the information may be customer characteristic information indicating how many men or women have purchased the product, or how many teenager customers or customers in their 20s have purchased the product. Purchase customer characteristics of each product may be obtained for a specific sales branch, and may be obtained according to preset time condition or periodic condition.

Purchase customer characteristics of each sales branch may be understood as information that matches a purchase amount at a specific sales branch with a customer with certain characteristics. For example, in an “A” sales branch, the information may be customer characteristics information identifying how many men have purchased products there and how many women have purchased products there, or how many teenager customers or customers in their 20s have purchased products there. Purchase customer characteristics of each sales branch may be obtained in more detail for a specific product, and may be obtained according to a preset time condition or periodic condition.

The customer facial information is information related to a facial image of an individual customer which is captured by the camera 260 included in each sales branch system 2000.

The product purchase information is information of a product purchase of an individual customer recognized by the POS terminal 240 included in the sales branch system 2000. Daily product purchase information and weekly product purchase information may be generated by collecting information of product purchases of individual customers, and the same may become product purchase information of the present embodiment.

The purchase customer characteristics may be at least one of a gender and an age of a customer, and each of the purchase customer characteristics may be classified into at least one type.

In an example, when the purchase customer characteristics are a customer gender, the purchase customer characteristics are classified into a male and a female.

In another example, when the purchase customer characteristics are a customer age, the purchase customer characteristics are classified according to an age range.

Meanwhile, the purchase customer characteristics may be classified into a complex type by combining a gender type and an age type.

The identification information of the sales branch is a unique code assigned to each sales branch system 1000 so as to be identified by the headquarters system 2000, and the purchase customer characteristics may be a gender or an age of a customer.

Examples of product purchase information and purchase customer characteristics will be described in more detail.

In an example, product purchase information may be calculated as a sales amount of each product item (unit: KRW), or may be calculated as a number of sales of each product item (unit: quantity), or may be calculated by selectively applying a calculation reference to each product.

In another example, product purchase information may be calculated in a unit of an individual product code (for example, ABC cola can 250 mm, ABC-milk chocolate-milk pack 200 mm), may be calculated in a unit of an individual product item (for example, cola, Sprite, chocolate-milk, strawberry milk), may be calculated in a unit of a general product item (for example, a soft drink, a milk product), or may be calculated by selectively applying the calculate reference according to product characteristics.

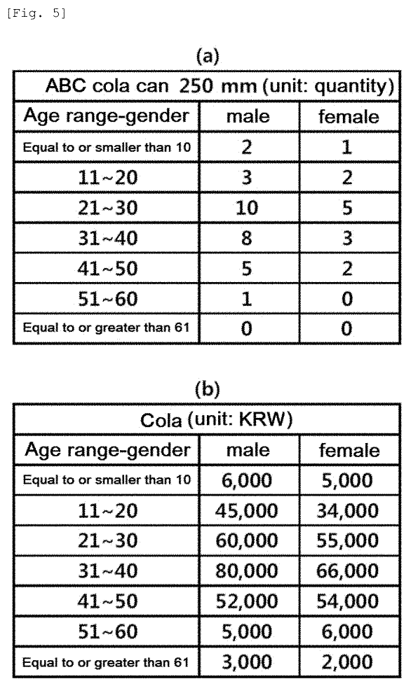

Purchase customer characteristics of each product may be generated, for example, as a data table of FIG. 5. The table shows an example where the purchase customer characteristics are classified into a combination of a gender type (male, female) and an age type (age range). Herein, the age range is divided by a unit of 10 years, but may be set to a larger or smaller age range.

FIG. 5(a) shows an example where product purchase information is calculated in a unit of an individual product code (for example, ABC cola can 250 mm) and in a quantity unit of each individual product code (unit: quantity). FIG. 5(b) shows an example where product purchase information is calculated in a unit of an individual product item (for example, cola) and in a sales amount (unit: KRW) of each individual product item.

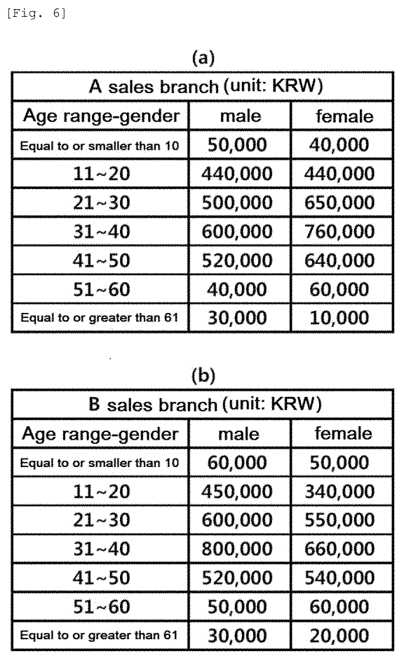

Purchase customer characteristics for each sales branch may be generated, for example, as a data table of FIG. 6.

FIG. 6(a) shows an example where product purchase information of “A” sales branch is calculated in a sales amount (unit: KRW). FIG. 6(b) shows an example where product purchase information of “B” sales branch is calculated in a sales amount (unit: KRW). Purchase customer characteristics of each sales branch may be obtained for the entire sold products or may be obtained for a specific product (individual product code, item, general item). When purchase customer characteristics of each sales branch are obtained for a specific product (individual product code, item, general item), purchase customer characteristics having a record identical to FIG. 5 may be obtained.

Preferably, in S1, the purchase customer characteristics of each product and the purchase customer characteristics of each sales branch may be obtained in a preset customer characteristic obtaining period.

For example, the purchase customer characteristics of each product and the purchase customer characteristics of each sales branch may be obtained in a unit of days, a unit of weeks, and a unit of months. In another example, the purchase customer characteristics of each product and the purchase customer characteristics of each sales branch may be configured in a time unit (minute, hour), or unlikely to time and date classification on a calendar, in a predetermined time unit or in a time range on the basis of a preset start time.

More preferably, the customer characteristic obtaining period may be managed in a separate period for each preset product.

In an example, for various kinds of products in small quantity, products with short shelf life such as fresh foods and dairy products, etc., and current affair related publications such as daily or weekly newspapers, a customer characteristic obtaining period is set and managed in a unit of days since such products are rotated faster than other products. In another example, for products with unlimited shelf life or a long shelf life, such as books and stockings, a customer characteristic obtaining period may be managed in a unit of weeks or in a unit of months.

When customer characteristic obtaining periods are managed in plural as described above, order management may be performed by grouping products manages in the same period.

The S1 may be configured in the following manner.

In S11, the headquarters system 2000 receives customer facial information, product purchase information, sales branch identification information from at least one sales branch system 2000.

In S12, the headquarters system 2000 obtains purchase customer characteristics of each product on the basis of the customer facial information and the product purchase information, and obtains purchase customer characteristics of each sales branch on the basis of the customer facial information and the sales branch identification information.

In other words, the above method is a method in which a facial recognition module (or facial recognition engine) is provided in the headquarters system 2000.

When the above method is used, the sales branch system 2000 ensures a storage space for storing customer facial images, and installing of a facial recognition engine in each individual system is not required.

In another example, S1 may be configured in the following manner.

In S101, the headquarters system 2000 receives and obtains purchase customer characteristics of each product and purchase customer characteristics of each sales branch from at least one of sales branch system 2000.

In other words, the above method is a method in which a facial recognition module (or facial recognition engine) is included in the sales branch system 2000.

When the above method is used, the sales branch system 2000 obtains purchase customer characteristics of each product on the basis of customer facial information and product purchase information, and the sales branch system 2000 obtains purchase customer characteristics of each sales branch on the basis of the customer facial information and the sales branch identification information.

When the above method is used, a facial recognition engine is installed in each sales branch system 2000, but an analyzed facial recognition processed result is transmitted to the headquarters system 1000 rather than transmitting a large amount of image files.

In S2, order reference information is provided to an individual sales branch system 2000.

The order reference information is generated on the basis of at least one of purchase customer characteristics of each product, and purchase customer characteristics of each sales branch, and is product information which is estimated to be purchased in the individual sales branch.

In an embodiment, the order reference information may be generated and provided in the following manner.

First, the headquarters system 1000 selects as a reference sales branch a sales branch that is classified to have high sales performance among a plurality of sales branches having the same type of purchase customer characteristics according to a preset reference.

Whether or not to have the same type of purchase customer characteristics may be determined by using a preset reference. For example, a total sales amount (unit: KRW) and a sales amount of each purchase customer characteristic for each sales branch are obtained for a preset period for each sales branch, sales branches having four purchase customer characteristics with the highest sales amount identical from each other may be determined as the sales branches having the same type of purchase customer characteristics.

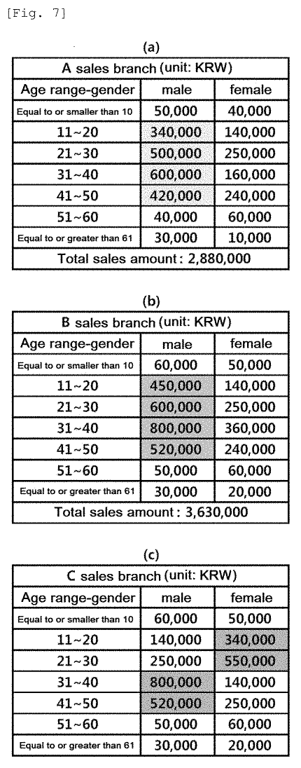

For example, referring to FIG. 7, four purchase customer characteristics with the highest sales amount of an A sales branch during a preset period (for example, daily or weekly) are a “male” and age ranges of “11 to 20”, “21 to 30”, “31 to 40”, and “41 to 50”, and a B sales branch has the same features.

Accordingly, the A sales branch and the B sales branch may be determined to have the same type of purchase customer characteristics. In other words, the A sales branch and the B sales branch may have the same customer base that performs purchase action.

Accordingly, products sales information of best sales branch having the better sales performance between the A sales branch and the B sales branch is provided to other sales branches as order reference information, and when the other sales branches reflect the information in their future order records, sales growth in the corresponding sales branch may be also be expected.

However, when four purchase customer characteristics with the highest sales amount of a C sales branch are a “male” and age ranges of “31 to 40” and “41 to 50”, and a “female” and age ranges of “11 to 20” and “21 to 30” during a preset period (for example, daily or weekly), the A sales branch and the C sales branch are not determined to have the same type of purchase customer characteristics. In other words, the two sales branches do not have the same customer base.

A reference for determining whether or not to have the same type of purchase customer characteristics may be determined by whether or not reference characteristics having the highest sales amount are identical. How many characteristics have to be identical, or whether or not a rank of the gender-age characteristics should be the same or a number of the characteristics should be the same may be variably configured by setting.

In FIG. 7, the headquarters system 1000 selects as a reference sales branch a sales branch that is classified to have the higher sales performance according to a preset reference (for example, total sales amount) between the A sales branch and the B sales branch having the same type of purchase customer characteristics. When a total sales amount is used as a reference, the B sales branch is selected as a reference sales branch since a total sales amount of the A sales branch is 2,880,000 KRW, and a total sales amount of the B sales branch is 3,630,000 KRW. A preset reference may be variably set, for example, a sales amount, a sum of sales amounts of four characteristics, etc.

Subsequently, the headquarters system 1000 generates product purchase information of the reference sales branch as order reference information for other sales branch systems 2000 having the same type of purchase customer characteristics.

For example, in FIG. 7, a product list with best sales performance of the B sales branch may be provided to the A sales branch as order reference information. Accordingly, the A sales branch may identify which product has the best sales performance in the B sales branch that has a similar customer base and higher sales performance, and reflect the same in a future order.

In another example, the order reference information may be generated and provided in the following manner.

First, the headquarters system 1000 selects as a reference product a product that is classified to have high sales performance among a plurality of products having the same type of purchase customer characteristics according to a preset reference.

Whether or not to have the same type of purchase customer characteristics may be determined according to a preset reference. For example, for each product sold in a specific sales branch, a total sales amount (unit: KRW) of each product and a sales amount of each purchase customer characteristics for a preset period are obtained, products having the same four purchase customer characteristics with the highest sales amount may be determined to have the same type of purchase customer characteristics.

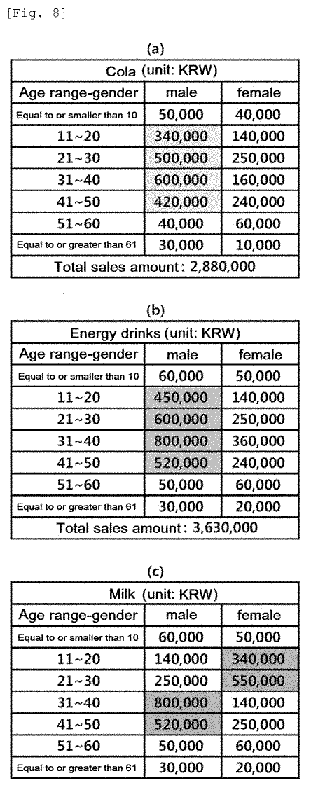

For example, referring to FIG. 8, in case of “cola”, when four purchase customer characteristics having the highest sales amount for a preset period (for example, daily or weekly) are a “male” and age ranges of “11 to 20”, “21 to 30”, “31 to 40”, and “41 to 50”, and the above characteristics are the same for “energy drinks”.

Accordingly, cola and energy drinks may be determined to have the same type of purchase customer characteristics. In other words, cola and energy drinks may be determined to have the same customer base that purchases the same.

Accordingly, information of a product having the better sales performance between cola and energy drinks may be provided to sales branches having the same type of purchase customer characteristics as order reference information, and the corresponding sales branches reflect the information in their future order records so as to increase in inventory of a product having best sales performance.

Meanwhile, in case of “milk”, when four purchase customer characteristics having the highest sales amount for a preset period (for example, daily or weekly) are a “male” and age ranges of “31 to 40” and “41 to 50”, and a “female” and age range of “11 to 20” and “21 to 30”, milk may be determined not to have the same type of purchase customer characteristics with cola and energy drinks.

A reference for determining whether or not to have the same type of purchase customer characteristics may be determined by whether or not reference characteristics having the highest sales amount are identical. How many characteristics have to be identical, or whether or not a rank of the gender-age characteristics should be the same or a number of the characteristics should be the same may be variably configured by setting.

In FIG. 8, the headquarters system 1000 selects as a reference product a product that is classified to have the higher sales performance according to a preset reference (for example, total sales amount) between cola and energy drinks having the same type of purchase customer characteristics. When a total sales amount is used as a reference, a total sales amount of cola is 2,880,000 KRW, and a total sales amount of energy drinks is 3,630,000 KRW, and thus energy drinks are selected as a reference product. A preset reference may be variably set, for example, a sales amount, a sum of sales amounts of four characteristics, etc.

Subsequently, the headquarters system 1000 generates and provides the information of the reference product as order reference information for sales branch systems 2000 having the same type of purchase customer characteristics with the purchase customer characteristics of the reference product.

For example, energy drinks is provided to sales branches (A sales branch and B sales branch of FIG. 7) having the same type of purchase customer characteristics with energy drinks of an example of FIG. 8 as order reference information. The A sales branch and the B sales branch have a customer base that prefers energy drinks, and thus sales may be improved as more inventory of energy drinks are prepared.

Preferably, in S2, providing the order reference information is performed according to a preset reference information providing period.

For example, providing the order reference information may be performed in a unit of days, a unit of weeks, and a unit of months. In another example, providing of the order reference information may be configured in a time unit (minute, hour), or unlikely to time and date classification on a calendar, in a predetermined time unit or in a time range on the basis of a preset start time.

More preferably, the reference information providing period may be managed in a separate period for each preset product.

In an example, for various kinds of products in small quantity, products with short shelf life such as fresh foods and dairy products, etc., and current affair related publications such as daily or weekly newspapers, a reference information providing period is set and managed in a unit of days since such products are rotated faster than other products. In another example, for products with unlimited shelf life or a long shelf life, such as books and stockings, a reference information providing period may be managed in a unit of weeks or a unit of months.

Meanwhile, the headquarters system 1000 manages inventory information of each product of individual sales branches. In an embodiment, inventory information may be managed in a manner similar to managing inventory information of a general convenience store chain network.

Preferably, in S2, in the order reference information provided to the individual sales branch system 2000, a product which remains in inventory a preset reference or more is not included in order reference information of the corresponding sales branch.

In S3, order information is received from the individual sales branch system 2000.

In S4, a payment preference condition is applied to a product included in the order reference information among products included in the order information. As a payment preference condition, a method of applying a preference condition to a product supply cost of the headquarters according to a preset condition, or a method of providing an event product or an event in the corresponding sales branch, etc. may be used.

By using the above payment preference condition, the headquarters may encourage the individual sales branch to actively use order reference information.

As a modified example of the above embodiment, the headquarters system 1000 may associate with the information providing agency system providing weather information.

Herein, the headquarters system 1000 may further obtain purchase customer characteristics for each weather state in S1.

In an example, the weather state may be classified into sunny/cloudy/rainy/snowy states, or hot/warm/cold states.

In addition, in S2, the order reference information may be generated on the basis of at least one of purchase customer characteristics of each product, purchase customer characteristics of each sales branch, and purchase customer characteristics of each weather state.

In the present embodiment, the order reference information may be generated in a method of the following embodiment.

First, the headquarters system 1000 selects as a reference sales branch a sales branch classified to having high sales performance among a plurality of sales branches having the same type purchase customer characteristics under one weather state (for example, hot).

Subsequently, the headquarters system 1000 generates and provides product purchase information of the reference sales branch as order reference information for other sales branch systems 2000 having the same type of purchase customer characteristics under the corresponding weather state.

In another example, the order reference information may be generated and provided in the following manner.

First, the headquarters system 1000 selects as a reference product a product that is classified to have high sales performance among a plurality of products having the same type of purchase customer characteristics under one weather state (for example, rainy).

Subsequently, the headquarters system 1000 generates and provides information of the reference product as order reference information to sales branch systems 2000 having the type of purchase customer characteristics which is identical to the purchase customer characteristics of the reference product under the corresponding weather state.

Providing order reference information in which a weather state is reflected is similar to an embodiment of FIGS. 7 and 8 described above differing in that a weather state is further reflected for determining purchase customer characteristics, and thus detailed description thereof will be omitted.

Meanwhile, in the above embodiment, purchase customer characteristics may be obtained through facial recognition of customers, and for the same, a camera is proposed as a means for obtaining customer facial information. However, in addition to facial recognition through a camera, a means capable of obtaining customer biological information including a gender, and an age of a customer may be used for generating purchase customer characteristics.

For example, gender and age recognition may be performed by analyzing customer voice. Herein, a microphone is used as a means for obtaining customer voice information, and a voice analysis engine using voice wavelength characteristics may be used for generating purchase customer characteristics.

Herein, in an example, when a gender and an age of a specific customer on the basis of customer facial information are identical to a gender and an age of the corresponding customer on the basis of customer voice information are identical, obtaining the purchase customer characteristics may identify the corresponding gender and the age as a gender and an age of the customer. In another example, considering recognition rates of facial recognition and voice recognition, a gender and an age may be determined by a weighted average of two recognition results(obtaining a weighted average by adding a weight to a recognition result having higher recognition rate). For recognition rates of facial recognition and voice recognition, recognition rate values provided from a facial recognition engine and a voice recognition engine may be used.

In other words, in the present embodiment, a voice recognition module (or voice recognition engine) may be provided in the headquarters system 2000 or may be provided in the sales branch system 2000 in a form similar to a facial recognition module (or facial recognition engine).

Embodiments of the present invention include a program for performing various computer-implemented operations and a computer-readable storage medium on which the program is recorded. The computer-readable storage medium may include stand-alone or a combination of program instructions, data files, and data structures. The computer-readable storage medium may be specially designed and configured for the present invention, or may also be known and available to those skilled in the computer software field. Examples of the computer-readable storage medium include a magnetic medium, such as a hard disk, a floppy disk, and a magnetic tape; an optical medium, such as a CD-ROM, a DVD, a USB; a magneto-optical medium such as a floptical disk; and a hardware device configured to store and perform program instructions such as a ROM, a RAM, a flash memory, etc. Examples of the program instructions include not only machine language codes made by a compiler but also high-level language codes executable by a device such as computer, for electronically processing information, by using an interpreter.

1. A sales management method, wherein the method is a product sales management method executed in a headquarters system in association with a sales branch system including a POS terminal and a camera through a network, the method comprising:
step 1) of obtaining purchase customer characteristics of each product and purchase customer characteristics of each sales branch based on customer facial information, product purchase information, and sales branch identification information obtained from at least one sales branch system,
wherein the customer facial information is facial information of an individual customer which is captured by the camera provided in each sales branch system, the product purchase information is product purchase information of an individual customer which is recognized by the POS terminal provided in each sales branch system, and the purchase customer characteristics are at least one of a gender and an age of a customer, and are classified into at least one type for each purchase customer characteristic; and
step 2) of providing order reference information to an individual sales branch system,
wherein the order reference information is generated based on at least one of purchase customer characteristics of each product and purchase customer characteristics of each sales branch, and is product information which is expected to be purchased in the individual sales branch.

2. The method of claim 1, wherein the step 1) includes:
step 11) of receiving the customer facial information, the product purchase information, and the sales branch identification information from at least one sales branch system; and
step 12) of obtaining the purchase customer characteristics of each product based on the customer facial information and the product purchase information, and obtaining the purchase customer characteristics of each sales branch based on the customer facial information and the sales branch identification information.

3. The method of claim 1, wherein the step 1) includes step 101) of obtaining the purchase customer characteristics of each product and the purchase customer characteristics of each sales branch by receiving the same from at least one sales branch system,
wherein the sales branch system obtains the purchase customer characteristics of each product based on the customer facial information and the product purchase information, and the sales branch system obtains the purchase customer characteristics of each sales branch based on the customer facial information and the sales branch identification information.

4. The method of claim 1, wherein the order reference information is configured to select as a reference sales branch a sales branch that is classified to have high sales performance according to a preset reference among a plurality of sales branch having an identical type of purchase customer characteristic, and to generate and provide product purchase information of the reference sales branch as order reference information for other sales branch systems having the identical type of purchase customer characteristic.

5. The method of claim 1, wherein the order reference information is configured to select as a reference product a product that is classified to have high sales performance according to a preset reference among a plurality of products having an identical type of purchase customer characteristic, and to generate and provide information of the reference product as order reference information for sales branch systems having a type of purchase customer characteristics which is identical to the purchase customer characteristics of the reference product.

6. The method of claim 1, wherein when the purchase customer characteristics are a customer gender, the purchase customer characteristics are classified into male and female types, and when the purchase customer characteristics are a customer age, the purchase customer characteristics are classified into types according to an age range.

7. The method of claim 6, wherein the purchase customer characteristics are classified by a combination type combining a gender type and an age type.

8. The method of claim 1, wherein in the step 1), the purchase customer characteristics of each product and the purchase customer characteristics of each sales branch are obtained in a preset customer characteristic obtaining period, and in the step 2), the order reference information is provided in a preset reference information providing period.

9. The method of claim 8, wherein at least one of the customer characteristic obtaining period and the reference information providing period is managed in a separate period preset for each product.

10. The method of claim 1, wherein the headquarters system further associates with an information providing agency system providing weather information, wherein
in the step 1), purchase customer characteristics of each weather state are further obtained, and
in the step 2), the order reference information is generated based on at least one of the purchase customer characteristics of each product, the purchase customer characteristics of each sales branch, and the purchase customer characteristics of each weather state.

11. The method of claim 10, wherein the order reference information is configured to select as a reference sales branch a sales branch that is classified to have high sales performance among a plurality of sales branches having an identical type of purchase customer characteristics under one weather state, and to generate and provide product purchase information of the reference sales branch as order reference information for other sales branch systems having the identical type of purchase customer characteristics under the corresponding weather state.

12. The method of claim 10, wherein the order reference information is configured to select as a reference product a product that is classified to have high sales performance among a plurality of products having an identical type of purchase customer characteristics under one weather state, and to generate and provide information of the reference product as order reference information for sales branch systems having a type of purchase customer characteristics which is identical to the purchase customer characteristics of the reference product under the corresponding weather state.

13. The method of claim 1, wherein the headquarters system further manages inventory information of each product for the individual sales branch, and in the step 2), in the order reference information provided to the individual sales branch system, a product which remains in inventory a preset reference or more is not included in order reference information of the corresponding sales branch.

14. The method of claim 1, further comprising:
step 3) of receiving order information from the individual sales branch system; and
step 4) of applying a preset payment preference condition to a product included in the order reference information among products included in the order information.

15. A sales management method, wherein the method is a product sales management method executed in a headquarters system in association with a sales branch system provided with a POS terminal, a camera, and a microphone through a network, the method comprising:
step 1) of obtaining purchase customer characteristics of each product and purchase customer characteristics of each sales branch based on at least one of customer facial information, customer voice information, product purchase information, and sales branch identification information obtained from at least one sales branch system,
wherein the customer facial information is facial information of an individual customer which is captured by the camera provided in each sales branch system, the customer voice information is voice information of an individual customer which is obtained from the microphone provided in each sales branch system, the product purchase information is product purchase information of an individual customer which is recognized from the POS terminal provided in each sales branch system, and the purchase customer characteristics are at least one of a gender and an age of a customer, and are classified into at least one type for each purchase customer characteristic; and
step 2) of providing order reference information to an individual sales branch system,
wherein the order reference information is generated based on at least one of the purchase customer characteristics of each product and the purchase customer characteristics of each sales branch, and is product information which is expected to be purchased in the individual sales branch.

16. A computer readable recording medium in which a computer program for executing a sales management method according to claim 1 is recorded.

17. A computer readable recording medium in which a computer program for executing a sales management method according to claim 15 is recorded.
